(19) United States
(12) Patent Application Publication
(10) Pub. No.: US 2026/0106839 A1
(43) Pub. Date: Apr. 16, 2026

(54) GATEWAY DEVICE AND METHOD OF OPTIMIZING NETWORK PACKET SIZE AT APPLICATION PROTOCOL LEVEL USING THE SAME

(71) Applicant: SEOUL NATIONAL UNIVERSITY R&DB FOUNDATION, Seoul (KR)

(72) Inventors: Kyoung Soo PARK, Seoul (KR); Jung Han YOON, Seoul (KR)

(21) Appl. No.: 19/419,107

(22) Filed: Dec. 15, 2025

Related U.S. Application Data
(63) Continuation of application No. PCT/KR2025/008130, filed on Jun. 13, 2025.

(30) Foreign Application Priority Data
Sep. 25, 2024 (KR) 10-2025-0129843
Apr. 8, 2025 (KR) 10-2025-0045471

(51) Int. Cl. H04L 47/36; H04L 47/193; H04L 47/34

(52) U.S. Cl. CPC H04L 47/365; H04L 47/193; H04L 47/34

(57) ABSTRACT

A gateway device and a method of optimizing a network packet size at an application protocol level using the same are provided, the method includes: receiving a plurality of first packets of a certain transmission control protocol (TCP)-based application protocol based on a first maximum transmission unit (MTU) size from an external network; identifying the plurality of received first packets in units of the same TCP flows; dynamically reassembling a plurality of second packets identified as the same TCP flow in accordance with protocol data units (PDUs) of the application protocol; converting the reassembled packets into at least one third packet with a second MTU size of an internal network or less; and transmitting the third packet to the internal network.

### CROSS REFERENCE TO RELATED APPLICATIONS

This application is a Bypass Continuation of International Patent Application No. PCT/KR2025/008130, filed on Jun. 13, 2025 that claims priority and the benefit of Korean Patent Application No. 10-2025-0045471, filed on Apr. 8, 2025, and Korean Patent Application No. 10-2024-0129843, filed on Sep. 25, 2024, each of which is hereby incorporated by reference for all purposes as if fully set forth herein.

### BACKGROUND

### FIELD

Embodiments of the invention relate to a gateway device and a method of optimizing a network packet size at an application protocol level using the same.

### DISCUSSION OF THE BACKGROUND

Currently, Internet protocol (IP) packets transmitted on the Internet are sized between the minimum and maximum sizes (64 bytes to 1500 bytes) of Ethernet frames that were proposed about 40 years ago. In general transmission control protocol (TCP) communication, packets are configured on the basis of a maximum transmission unit (MTU) size on a network route. However, frequent mismatches between data units (e.g., a block size of transport layer security (TLS) records or non-volatile memory express over fabrics (NVMe-oF) TCP) processed by an application protocol and a network MTU size may degrade network transmission and require additional packer reassembly at a receiving side.

Basically, the TCP/IP protocol stack transmits packets in accordance with an MTU size, where a transmitting side divides large data and transmits small packets and a receiving side reassembles the small packets into an original data stream. However, this is performed only in the TCP layer and does not take into account data units and integrity of an application protocol, which causes performance degradation of the application protocol. In particular, application protocols, such as TLS and NVMe-oF TCP, process data in units of specific-size records. Accordingly, when a network packet size does not match a record size of an application protocol, additional overhead is incurred for packet combination.

For example, the TLS protocol has a structure for encrypting and protecting data in units of certain-size TLS records. However, when an MTU size differs from a TLS record size in a network environment, TLS records may be divided into several packets and transmitted. In this case, a receiving side should reassemble several packets to completely restore a TLS record, which requires a buffering process. During this process, computation load on a central processing unit (CPU) on the receiving side increases, and latency may be incurred until the packets are sorted correctly.

The NVMe-oF TCP protocol also has similar issues. NVMe-oF is a protocol supporting high-speed data transmission with a remote storage device, and for this protocol, it is generally optimal to process data on the basis of a 4 KB block size. However, when an existing network MTU is set to 1500 bytes, one 4 KB block is divided into several packets and transmitted. In this case, a receiving side should reassemble the several packets to restore the 4 KB block, and this process involves unnecessary memory copying and buffering, which degrades performance. In particular, NVMe-oF TCP is used in high-performance storage systems. Accordingly, when a data processing rate is lowered due to the inefficient setting of a network packet size, overall input/output (I/O) performance may be significantly affected.

Therefore, to address these issues of the conventional art, a new scheme for optimizing packets in accordance with record units of the application protocol or units for optimizing performance in the middle of a network is necessary.

The above information disclosed in this Background section is only for understanding of the background of the inventive concepts, and, therefore, it may contain information that does not constitute prior art.

### SUMMARY

The present application is directed to providing a gateway device and a method of optimizing a network packet size at an application protocol level using the same.

Additional features of the inventive concepts will be set forth in the description which follows, and in part will be apparent from the description, or may be learned by practice of the inventive concepts.

According to an embodiment of the present application, a method of optimizing a network packet size at an application protocol level using a gateway device is provided. The method includes receiving a plurality of first packets of a certain transmission control protocol (TCP)-based application protocol based on a first maximum transmission unit (MTU) size from an external network, identifying the plurality of received first packets in units of the same TCP flows, dynamically reassembling a plurality of second packets identified as the same TCP flow in accordance with protocol data units (PDUs) of the application protocol, converting the reassembled packets into at least one third packet with a second MTU size of an internal network or less, and transmitting the third packet to the internal network.

In addition, the second MTU size may be larger than the first MTU size.

In addition, the reassembling of the plurality of second packets may be performed by merging the plurality of second packets such that whole PDUs of the application protocol may be included in the reassembled packets.

In addition, the converting of the reassembled packets into the at least one third packet may be performed by segmenting the reassembled packets into a plurality of packets with a size of the PDU when a size of the reassembled packets exceeds the size of the PDU.

In addition, the converting of the reassembled packets into the at least one third packet may be performed by merging the plurality of reassembled packets such that the third packet may include a plurality of PDUs of the application protocol.

In addition, the reassembling of the plurality of second packets may be performed by merging contiguous second packets in order on the basis of sequence numbers of TCP headers.

In addition, the identifying of the plurality of received first packets in units of the same TCP flows may be performed on the basis of at least one of an origin Internet protocol (IP) address, a destination IP address, an origin port number, a destination port number, and protocol information extracted from headers of the first packets.

In addition, the application protocol may include a transport layer security (TLS) protocol and a non-volatile memory express over fabrics (NVMe-oF) TCP protocol.

According to an embodiment of the present application, a computer program is provided. The program may be stored in a recording medium to perform the method according to the embodiment of the present application.

According to an embodiment of the present application, a gateway device for optimizing a network packet size at an application protocol level is provided. The device may include a packet reception unit configured to receive a plurality of first packets of a certain TCP-based application protocol based on a first MTU size from an external network, a flow processing unit configured to identify the plurality of received first packets in units of the same TCP flows, a packet conversion unit configured to dynamically reassemble a plurality of second packets identified as the same TCP flow in accordance with PDUs of the application protocol and convert the reassembled packets into at least one third packet with a second MTU size of an internal network or less, and a packet transmission unit configured to transmit the third packet to the internal network.

According to an embodiment of the present application, a method of optimizing a network packet size at an application protocol level using a gateway device is provided. The method includes receiving a plurality of first packets of a certain TCP-based application protocol based on a MTU size from an external network, identifying the plurality of received first packets in units of the same TCP flows, dynamically reassembling a plurality of second packets identified as the same TCP flow in accordance with certain data processing units for optimizing performance of the application protocol, converting the reassembled packets into at least one third packet with a second MTU size of an internal network or less, and transmitting the third packet to the internal network.

According to an embodiment of the present application, a gateway device for optimizing a network packet size at an application protocol level is provided. The device may include a packet reception unit configured to receive a plurality of first packets of a certain TCP-based application protocol based on a first MTU size from an external network, a flow processing unit configured to identify the plurality of received first packets in units of the same TCP flows, a packet conversion unit configured to dynamically reassemble a plurality of second packets identified as the same TCP flow in accordance with certain data processing units for optimizing performance of the application protocol and convert the reassembled packets into at least one third packet with a second MTU size of an internal network or less, and a packet transmission unit configured to transmit the third packet to the internal network.

According to embodiments of the present application, it is possible to optimize network packets by dynamically merging and segmenting the network packets in accordance with a record unit of an application protocol or units for optimizing performance. In this way, a packet combination and buffering process that is not necessary for reception is removed. As a result, a packet transmission rate is increased, and latency is reduced, which can significantly improve network and application processing performance.

In addition, according to embodiments of the present application, the overhead of packet reassembly incurred in application protocols such as transport layer security (TLS) and non-volatile memory express over fabrics (NVMe-oF) transmission control protocol (TCP) is removed, and thus it is possible to prevent inefficient data processing between the network and application layers.

In addition, according to embodiments of the present application, it is possible to have high compatibility with existing TCP-based networks and applications. Accordingly, embodiments of the present application can be directly applied without additional software or hardware changes, and the effect of performance improvement can be directly obtained in various network environments.

Effects that can be achieved from embodiments of the present application are not limited to those described above, and other effects that have not been described will be clearly understood by those of ordinary skill in the technical field to which the present application pertains from the following description.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a block diagram illustrating a system for optimizing a network packet size at an application protocol level according to an embodiment of the present application.

FIG. 2 is a block diagram illustrating a hardware configuration of a gateway device for optimizing a network packet size at an application protocol level according to an embodiment of the present application.

FIG. 3 is a block diagram illustrating a functional configuration of the gateway device for optimizing a network packet size at an application protocol level according to the embodiment of the present application.

FIG. 4 is a flowchart of a method of optimizing a network packet size at an application protocol level according to an embodiment of the present application.

FIG. 5 is a diagram showing an implementation example of the system for optimizing a network packet size at an application protocol level according to the embodiment of the present application.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z—axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

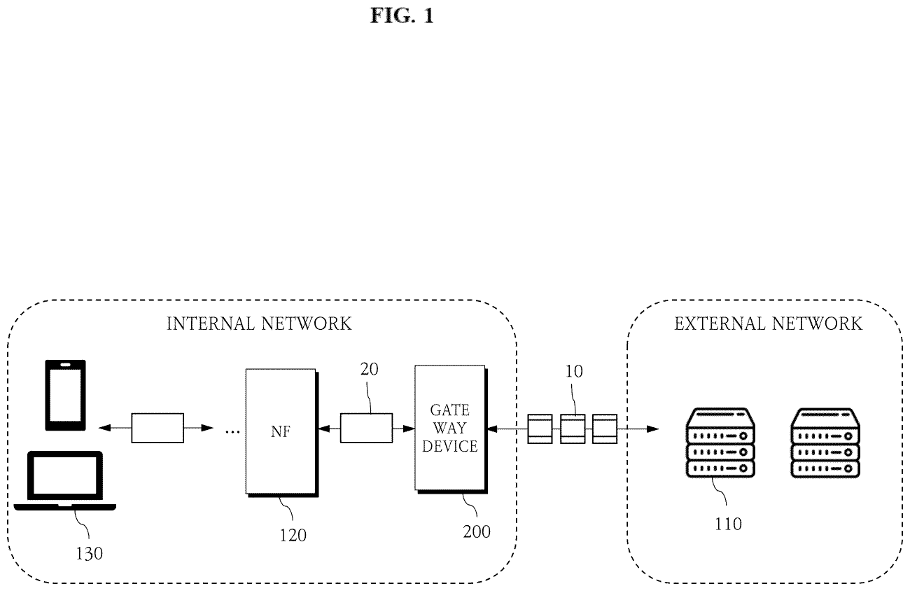

FIG. 1 is a block diagram illustrating a system for optimizing a network packet size at an application protocol level according to an embodiment of the present application.

Referring to FIG. 1, a system for optimizing a network packet size at an application protocol level according to an embodiment of the present application may be composed of an internal network and an external network and may include a gateway device 200 that changes a packet size in units of application protocol records.

The external network may include a public network, such as the Internet, and data may be transmitted on the basis of various application protocols such as transport layer security (TLS), non-volatile memory express over fabrics (NVMe-oF) transmission control protocol (TCP), hypertext transfer protocol (HTTP), and the like. The external network may be connected to an NVMe solid-state disk (SSD), a streaming device, and an external server 110 that requires other high-speed data processing. Such external servers 110 may transmit high-resolution images, massive storage data, real-time streaming data, and the like, to a destination node in the internal network via the external network, the gateway device 200, the internal network, and the like.

In the external network, data may be divided on the basis of a first maximum transmission unit (MTU) size and transmitted. For example, when the TLS protocol is used, data may be divided into TLS record units first and then encrypted, and subsequently, the encrypted data may be divided again into IP packets 10 in accordance with the first MTU (e.g., 1500 bytes) of the external network and transmitted through TCP. Similarly, when NVMe-oF TCP is used, data is generated on the basis of NVMe-oF storage block units or data transmission units (e.g., 4 KB block size), but the data may be divided into several packets 10 in accordance with the first MTU size of the external network and transmitted.

The gateway device 200 performs a function of optimizing a packet size at an application protocol level. The gateway device 200 may receive the packets 10 transmitted from the external network, identify packets belonging to the same TCP flow, and dynamically merge or segment packets in accordance with protocol data units (PDUs) of the application protocol, that is, PDUs of the application layer (Layer 7). In this way, packets may be reassembled such that PDUs of the application protocol may be wholly included. According to the embodiment, the gateway device 200 may reassemble packets on the basis of certain data processing units for optimizing performance of the application protocol. When a size of PDUs is very large such as that of the NVMe-oF TCP protocol, it may be efficient not to process the whole PDUs as single packets but to reassemble packets by aligning the packets in accordance with meaningful small units such as memory pages (e.g., 4 KB) or disk blocks defined in the PDUs or units processed by a system (e.g., operating system (OS)) of a receiving host.

In addition, the gateway device 200 may convert the reassembled packets in accordance with an MTU size of the internal network and transmit the converted packets to the internal network.

The internal network may include various network functions (NFs) 120 and host devices 130. The host devices 130 may be implemented as various devices, for example, a computer, a smartphone, a virtual reality (VR) device, an Internet protocol television (IPTV), and the like, and may communicate with the external network via the internal network. The internal network transmits packets 20 on the basis of a second MTU size, which may differ from the first MTU size of the external network. For example, the second MTU size may be set to 9000 bytes to transmit the packets 20.

The host devices 130 of the internal network may receive the packets 20 converted through the gateway device 200 and perform application protocol processing on the basis of the converted packets 20. Since record units of the application protocol are wholly included in the received packets 20, the host devices 130 can immediately perform decoding, application data processing, and the like, without additional recombination.

The configuration of the system shown in FIG. 1 is illustrative and may have various modifications in accordance with embodiments of the present application.

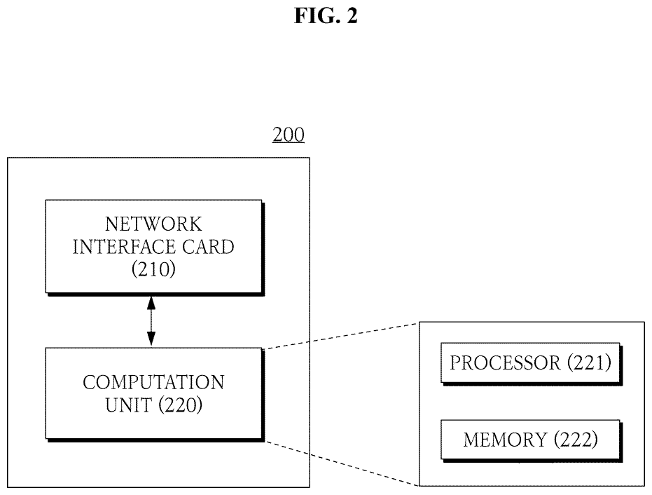

FIG. 2 is a block diagram illustrating a hardware configuration of a gateway device for optimizing a network packet size at an application protocol level according to an embodiment of the present application.

Referring to FIG. 2, the gateway device 200 may include a network interface card (NIC) 210 and a computation unit 220.

The NIC 210 is a hardware module that performs data transmission and reception between the external network and the internal network, and may perform a function of receiving and transmitting network packets. Also, the NIC 210 may perform a function of analyzing header information of received packets to identify a flow and classifying the packets by TCP flow. Also, the NIC 210 may utilize a large receive offload (LRO) module and a TCP segmentation offload (TSO) module to process at least some packets or transmit data to the computation unit 220. For example, the LRO module may merge packets as large as a PDU size of an application protocol, and when the packet merged by the LRO module exceeds the PDU size of the application protocol, the TSO module may segment the merged packet into PDUs. Also, according to the embodiment, the LRO module may merge packets on the basis of certain data processing units for optimizing performance of the application protocol. For example, the LRO module may merge packets on the basis of data processing units (i.e., specific data processing units such as memory pages, disk blocks, and the like) defined in PDUs. In addition, the TSO module may perform a function of segmenting a merged packet in accordance with corresponding data processing units.

The NIC 210 may include, but is not limited to, a data processing and transmission module, a packet offloading module (the LRO module, the TSO module, and the like), a buffer, an internal memory, a controller, and the like.

The computation unit 220 is a central computation module that reassembles packets received from the NIC 210 and changes a network packet size.

The computation unit 220 may include a processor 221 and a memory 222.

The processor 221 performs main computations, such as managing a flow of packets, reassembling packets, and adjusting a packet size, using a program and/or data stored in the memory 222. The processor 221 may be a CPU or a dedicated processor for performing at least some methods according to embodiments of the present application.

The memory 222 performs packet buffering, packet header and metadata storage, and the like, and may support data processing of the computation unit 220. For example, the memory 222 may include at least one type of storage medium among a flash memory type, a hard disk type, a multimedia card micro type, a card type memory (e.g., a secure digital (SD) or extreme digital (XD) memory, and the like), a random access memory (RAM), a static RAM (SRAM), a read-only memory (ROM), an electrically erasable programmable ROM (EEPROM), a programmable ROM (PROM), a magnetic memory, a magnetic disk, and an optical disc.

The configuration of the device 200 shown in FIG. 2 is illustrative and may have various modifications in accordance with embodiments of the present application.

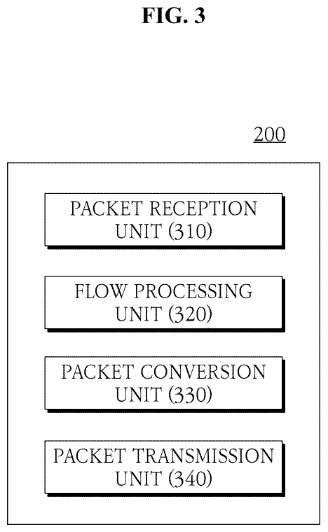

FIG. 3 is a block diagram illustrating a functional configuration of the gateway device for optimizing a network packet size at an application protocol level according to the embodiment of the present application.

Referring to FIG. 3, the gateway device 200 may include a packet reception unit 310, a flow processing unit 320, a packet conversion unit 330, and a packet transmission unit 340. The functional elements of FIG. 3 may be implemented by the hardware elements and/or software described above with reference to FIG. 2.

The packet reception unit 310 is implemented in the NIC 210 and may receive a plurality of first packets with a first MTU size or less from the external network. Here, the plurality of first packets may be generated by dividing data which is in units of PDUs of an application protocol into a plurality of packets on the basis of the first MTU. As will be described in detail below, through the packet conversion unit 330, the first packets may be merged into a third packet with a second MTU size or less which is suited to the application protocol and an internal network.

The flow processing unit 320 may be implemented in the NIC 210 and may identify the plurality of packets in flow units. According to the embodiment, a flow may be identified on the basis of at least two of an origin IP address, a destination IP address, an origin port number, a destination port number, and protocol information extracted from headers of the first packets. For example, the flow processing unit 320 may be configured to generate a receive side scaling (RSS) hash value on the basis of the information extracted from the headers of the received first packets and rapidly map the first packets to a specific flow on the basis of the RSS hash value.

The packet conversion unit 330 may dynamically merge a plurality of second packets identified as the same TCP flow in accordance with PDUs of the application protocol. In this way, packets may be reassembled such that PDUs of the application protocol may be wholly included. Also, the packet conversion unit 330 may convert a reassembled packet into at least one third packet by segmenting the reassembled packet in accordance with the PDU size of the application protocol. Further, according to the embodiment, the packet conversion unit 330 may perform a function of reassembling packets on the basis of certain data processing units for optimizing performance of the application protocol and converting packets in accordance with the corresponding units. For example, the certain data processing units may be PDUs themselves (e.g., TLS records), subunits (e.g., 4 KB memory pages in NVMe-oF PDUs) defined in PDUs, or units optimized for a system architecture (e.g., OS memory page and SSD physical block sizes) of a receiving host.

The packet conversion unit 330 may be implemented by the LRO module and/or the TSO module of the NIC 210 and the computation unit 220. For example, the LRO module and the computation unit 220 may sequentially merge packets belonging to the same TCP flow in units of PDUs of the application protocol or in the certain data processing units for optimizing performance of the application protocol, and the TSO module may segment packets transmitted to the internal network in an appropriate size for the PDU size of the application protocol and transmit the segmented packets.

The packet transmission unit 340 may transmit the third packet generated through conversion by the packet conversion unit 330 to the internal network or a destination node (a host device).

The configuration of the device 200 shown in FIG. 3 is illustrative and may have various modifications in accordance with embodiments of the present application.

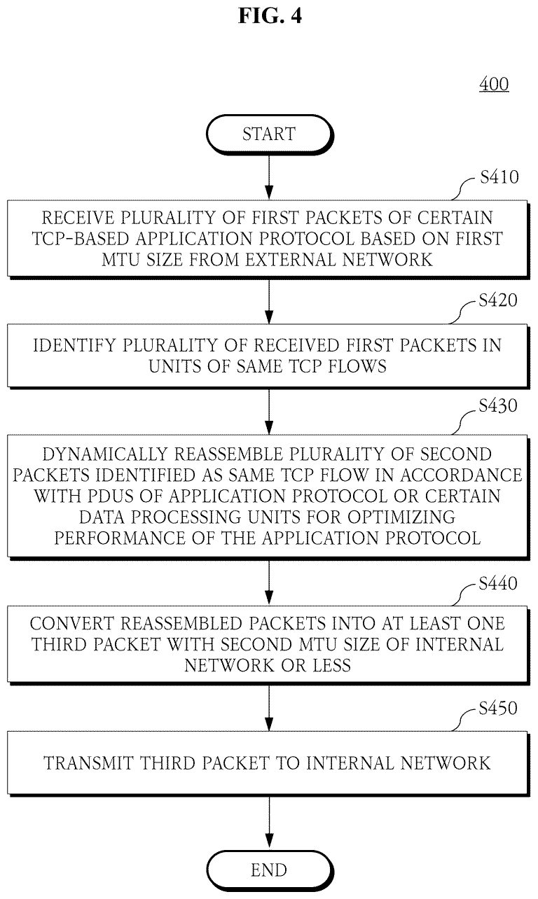

FIG. 4 is a flowchart of a method of optimizing a network packet size at an application protocol level according to an embodiment of the present application.

In operation S410, the gateway device 200 may receive a plurality of first packets of a certain TCP-based application protocol based on a first MTU size from an external network. Operation S410 may be performed by the packet reception unit 310 of FIG. 3.

Here, the application protocol may include TLS and NVMe-oF TCP.

According to the embodiment, the external network may be a public network such as the Internet, and the first MTU may be 1500 bytes. In other words, data may be divided on the basis of the first MTU size and transmitted in the external network. For example, when the TLS protocol is used, data may be encrypted in TLS record units, and then, based on TCP, the encrypted data may be divided into a plurality of first packets in accordance with the first MTU (1500 bytes) of the external network and transmitted to the gateway device 200. Similarly, when NVMe-oF TCP is used, data is generated on the basis of NVMe-oF storage block units or data transmission units (e.g., 4 KB block size), and the data may be divided into a plurality of first packets in accordance with the first MTU size of the external network and transmitted to the gateway device 200.

In operation S420, the gateway device 200 may identify the plurality of received first packets in units of the same TCP flows. Operation S420 may be performed by the flow processing unit 320 of FIG. 3.

Here, a flow may be a stream of packets with the same 5-tuple.

According to the embodiment, operation S420 may be performed on the basis of at least one of an origin IP address, a destination IP address, an origin port number, a destination port number, and protocol information extracted from headers of the first packets. For example, packets that have the same origin and destination IP addresses and port information and are transmitted using the same protocol may be considered as one flow.

The gateway device 200 may utilize a receive side scaling (RSS) hash value of the NIC 210 to optimize flow identification. In other words, the gateway device 200 may extract an origin IP address, a destination IP address, an origin port, a destination port, protocol information, and the like, from a header of a packet to generate a hash value and may rapidly map the packet to a specific flow.

In operation S430, the gateway device 200 may dynamically reassemble a plurality of second packets identified as the same TCP flow in accordance with a PDU size of the application protocol.

According to the embodiment, operation S430 may be performed by merging contiguous second packets in order on the basis of sequence numbers of TCP headers. First, the gateway device 200 may sort contiguous packets on the basis of TCP sequence numbers of the second packets. Subsequently, the gateway device 200 may merge the second packets that have been sorted on the basis of records or storage block boundaries of the application protocol, but may make an adjustment such that at least one PDU of the application protocol may be wholly included in one reassembled packet. For example, in the case of the TLS protocol, a plurality of second packets may be merged such that one whole TLS record may be included, and in the case of NVMe-oF TCP, the plurality of second packets may be merged such that a 4 KB or 8 KB size storage block may be included in one packet.

According to the embodiment, merging may be performed on the basis of certain data processing units for optimizing performance of the application protocol rather than whole PDUs. For example, in the case of the NVMe-oF TCP protocol in which a size of single PDUs is hundreds of kilobytes, the whole PDUs are not reassembled as single packets, but rather packets may be merged in accordance with meaningful boundaries such as memory page units (e.g., 4 KB) defined in the PDUs or disk block units or memory page units used by a system (e.g., OS) of a receiving host. In this way, data processing efficiency of a follow-up device 130 can be optimized.

In operation S440, the gateway device 200 may convert the reassembled packets into at least one third packet with a second MTU or less on the basis of the PDU size of the application protocol and/or the second MTU size of the internal network.

First, when a size of the reassembled packets is the second MTU size or less, the gateway device 200 may transmit the packets to the internal network without any change.

In addition, according to the embodiment, the gateway device 200 may merge the plurality of reassembled PDUs or certain data processing units into one third packet (e.g., by merging three 3000-byte PDUs) with the second MTU size or less.

In operation S450, the gateway device 200 may transmit the third packet to a destination node (i.e., a host device) in the internal network. Operation S450 may be performed by the packet transmission unit 340 of FIG. 3.

According to the embodiment, the third packet may be transmitted to the internal network through the TSO module of the NIC 210.

With the packet conversion and optimization process according to the embodiment of the present application, it is possible to increase packet processing efficiency of an internal network, and a host device reduces unnecessary packet reassembly and overhead at an application protocol level, which can improve system performance.

Meanwhile, the method 400 shown in FIG. 4 is illustrative and may have various modifications in accordance with embodiments of the present application.

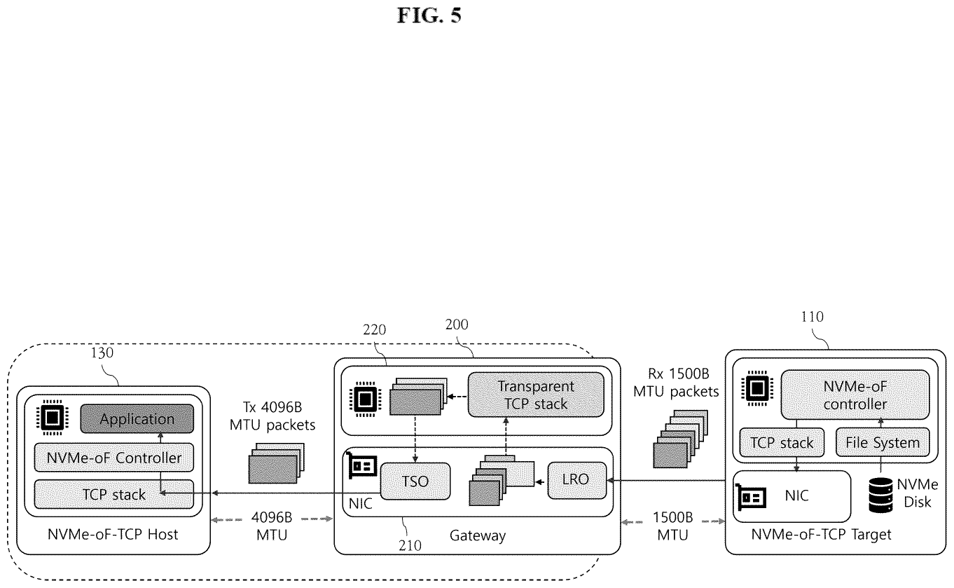

FIG. 5 is a diagram showing an implementation example of the system for optimizing a network packet size at an application protocol level according to the embodiment of the present application. Specifically, FIG. 5 illustrates a gateway device 200 that performs packet size changes and optimization on the basis of the NVMe-oF TCP protocol and the system including the gateway device 200.

Referring to FIG. 5, the system may include an external server 110, the gateway device 200, and a host device 130 constituting an internal network.

The external server 110 may include an NVMe-oF controller, a TCP stack, a file system, an NVMe disk, an NIC, and the like. The external server 110 may input and output storage data on the basis of the NVMe-oF protocol and convert data through the TCP stack to transmit the converted data. The NIC may segment packets in units of MTUs with a 1500-byte size suited to an external network through TSO and transmit the MTU packets to the gateway device 200.

The gateway device 200 performs a function of analyzing the MTU packets with a 1500-byte size received from the external network and optimizing the packet size at an application protocol level to convert the MTU packets to fit an MTU size of the internal network.

Specifically, the gateway device 200 may identify packets belonging to the same TCP flow on the basis of the TCP stack analyze the NVMe-oF protocol to reassemble packets in units of storage blocks of the application protocol. In this way, packets that have been divided and transmitted in 1500-byte units can be merged into whole NVMe-oF data block units (e.g., 4 KB). Also, when NVMe-oF PDUs themselves are significantly larger than 4 KB (e.g., 256 KB), the gateway device 200 may not merge the whole PDUs into single packets but may reassemble packets in accordance with memory page boundaries (e.g., 4 KB) which are data processing units smaller than the PDUs to optimize performance of the application protocol. The optimized packets can be converted to fit the MTU size of the internal network. Here, the MTU of the internal network may be 4096 bytes, and accordingly, the gateway device 200 may transmit data of one storage block unit to the internal network.

Here, the gateway device 200 is composed of an NIC 210 and a computation unit 220 and may optimize a packet conversion process by utilizing a network offload function such as TSO and LRO.

The packets converted through the gateway device 200 may be transmitted to the host device 130 which is a destination in the internal network.

The host device 130 may include an application, an NVMe-oF controller, a TCP stack, and the like. The host device 130 may process the packets in storage block units received from the gateway device 200 and input and output storage data on the basis of the NVMe-oF protocol. To this end, the TCP stack may receive the converted packets from the gateway device 200 and transmit the converted packets to the NVMe-oF controller. The NVMe-oF controller may interpret the data received from the TCP stack and store the data in an NVMe disk through a file system or read data from the NVMe disk and transmit the read data to the application.

As described above, the system according to the embodiment of the present application is implemented to convert packets received from an external network in units of storage blocks of an application protocol or certain data processing units for optimizing performance of the application protocol through the gateway device 200 and transmit the converted packets in an optimized form for an internal network. Accordingly, the host device 130 can be supported to immediately utilize the received data on the application without additional packet reassembly.

Meanwhile, the configuration of the system shown in FIG. 5 is illustrative and may have various modifications in accordance with embodiments of the present application.

The method according to the embodiment of the present application may be implemented in the form of program instructions that may be executed by various computing means and recorded on a computer-readable medium. The computer-readable medium may include program instructions, data files, data structures, and the like, solely or in combination. The program instructions recorded on the medium may be specially designed and configured for the present application or may be known and available to those skilled in the computer software field. Examples of the computer-readable recording medium include magnetic media such as a hard disk, a floppy disk, and magnetic tape, optical media such as a compact disc (CD)-ROM and a digital versatile disc (DVD), magneto-optical media such as a floptical disk, and hardware devices such as a ROM, a RAM, a flash memory, and the like, specially configured to store and execute program instructions. Examples of the program instructions include not only machine code created by a compiler but also high-level language code that can be executed by a computer using an interpreter.

In addition, the method according to the disclosed embodiment may be included and provided in a computer program product. The computer program product may be traded as goods between a seller and a buyer.

The computer program product may include a software (S/W) program and a computer-readable storage medium in which the S/W program is stored. For example, the computer program product may include a product (e.g., a downloadable application) in the form of a S/W program electronically distributed through a manufacturer of an electronic device or an electronic market (e.g., Google Play Store™ or App Store™). For the electronic distribution, at least a part of the S/W program may be stored in a storage medium or temporarily generated. In this case, the storage medium may be a storage medium of a server of the manufacturer or the electronic market or a relay server that temporarily stores the S/W program.

In a system including a server and a client device, the computer program product may include a storage medium of the server or a storage medium of the client device. Alternatively, when there is a third device (e.g., a smartphone) connected to the server or the client device for communication, the computer program product may include a storage medium of the third device. Alternatively, the computer program product may include a S/W program itself, which is transmitted from the server to the client device or the third device or transmitted from the third device to the client device.

In this case, one of the server, the client device, and the third device may execute the computer program product to perform the method according to the disclosed embodiment. Alternatively, two or more of the server, the client device, and the third device may execute the computer program product to perform the method according to the disclosed embodiment in a distributed manner.

For example, the server (e.g., a cloud server, an artificial intelligence server, and the like) may execute the computer program product stored in the server to control the client device connected to the server for communication such that the client device may perform the method according to the disclosed embodiment.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A method of optimizing a network packet size at an application protocol level using a gateway device, the method comprising:
receiving a plurality of first packets of a certain transmission control protocol (TCP)-based application protocol based on a first maximum transmission unit (MTU) size from an external network;
identifying the plurality of received first packets in units of the same TCP flows;
dynamically reassembling a plurality of second packets identified as the same TCP flow in accordance with protocol data units (PDUs) of the application protocol;
converting the reassembled packets into at least one third packet with a second MTU size of an internal network or less; and
transmitting the third packet to the internal network.

2. The method of claim 1, wherein the second MTU size is larger than the first MTU size.

3. The method of claim 1, wherein the reassembling of the plurality of second packets is performed by merging the plurality of second packets such that whole PDUs of the application protocol are included in the reassembled packets.

4. The method of claim 3, wherein the converting of the reassembled packets into the at least one third packet is performed by segmenting the reassembled packets into a plurality of packets with a size of the PDUs which is equal to or less than the second MTU size when a size of the reassembled packets exceeds the size of the PDU.

5. The method of claim 3, wherein the converting of the reassembled packets into the at least one third packet is performed by merging the plurality of reassembled packets such that the third packet includes a plurality of PDUs of the application protocol.

6. The method of claim 3, wherein the reassembling of the plurality of second packets is performed by merging contiguous second packets in order on the basis of sequence numbers of TCP headers.

7. The method of claim 1, wherein the identifying of the plurality of received first packets in units of the same TCP flows is performed on the basis of at least one of an origin Internet protocol (IP) address, a destination IP address, an origin port number, a destination port number, and protocol information extracted from headers of the first packets.

8. The method of claim 1, wherein the application protocol includes a transport layer security (TLS) protocol and a non-volatile memory express over fabrics (NVMe-oF) TCP protocol.

9. A computer program stored in a recording medium to perform a method of optimizing a network packet size at an application protocol level using a gateway device, the method comprising:
receiving a plurality of first packets of a certain transmission control protocol (TCP)-based application protocol based on a first maximum transmission unit (MTU) size from an external network;
identifying the plurality of received first packets in units of the same TCP flows;
dynamically reassembling a plurality of second packets identified as the same TCP flow in accordance with protocol data units (PDUs) of the application protocol;
converting the reassembled packets into at least one third packet with a second MTU size of an internal network or less; and
transmitting the third packet to the internal network.

10. The computer program of claim 9, wherein the second MTU size is larger than the first MTU size.

11. The computer program of claim 8, wherein the reassembling of the plurality of second packets is performed by merging the plurality of second packets such that whole PDUs of the application protocol are included in the reassembled packets.

12. The computer program of claim 11, wherein the converting of the reassembled packets into the at least one third packet is performed by segmenting the reassembled packets into a plurality of packets with a size of the PDUs which is equal to or less than the second MTU size when a size of the reassembled packets exceeds the size of the PDU.

13. The computer program of claim 11, wherein the converting of the reassembled packets into the at least one third packet is performed by merging the plurality of reassembled packets such that the third packet includes a plurality of PDUs of the application protocol.

14. The computer program of claim 11, wherein the reassembling of the plurality of second packets is performed by merging contiguous second packets in order on the basis of sequence numbers of TCP headers.

15. The computer program of claim 9, wherein the identifying of the plurality of received first packets in units of the same TCP flows is performed on the basis of at least one of an origin Internet protocol (IP) address, a destination IP address, an origin port number, a destination port number, and protocol information extracted from headers of the first packets.

16. The computer program of claim 9, wherein the application protocol includes a transport layer security (TLS) protocol and a non-volatile memory express over fabrics (NVMe-oF) TCP protocol.

17. A gateway device for optimizing a network packet size at an application protocol level, the gateway device comprising:
a packet reception unit configured to receive a plurality of first packets of a certain transmission control protocol (TCP)-based application protocol based on a first maximum transmission unit (MTU) size through an external network;
a flow processing unit configured to identify the plurality of received first packets in units of the same TCP flows;
a packet conversion unit configured to dynamically reassemble a plurality of second packets identified as the same TCP flow in accordance with protocol data units (PDUs) of the application protocol and convert the reassembled packets into at least one third packet with a second MTU size of an internal network or less; and
a packet transmission unit configured to transmit the third packet to the internal network.

18. A method of optimizing a network packet size at an application protocol level using a gateway device, the method comprising:
receiving a plurality of first packets of a certain transmission control protocol (TCP)-based application protocol based on a first maximum transmission unit (MTU) size from an external network;
identifying the plurality of received first packets in units of the same TCP flows;
dynamically reassembling a plurality of second packets identified as the same TCP flow in accordance with certain data processing units for optimizing performance of the application protocol;
converting the reassembled packets into at least one third packet with a second MTU size of an internal network or less; and
transmitting the third packet to the internal network.

19. A gateway device for optimizing a network packet size at an application protocol level, the gateway device comprising:
a packet reception unit configured to receive a plurality of first packets of a certain transmission control protocol (TCP)-based application protocol based on a first maximum transmission unit (MTU) size from an external network;
a flow processing unit configured to identify the plurality of received first packets in units of the same TCP flows;
a packet conversion unit configured to dynamically reassemble a plurality of second packets identified as the same TCP flow in accordance with certain data processing units for optimizing performance of the application protocol and convert the reassembled packets into at least one third packet with a second MTU size of an internal network or less; and
a packet transmission unit configured to transmit the third packet to the internal network.
